(19) United States
(12) Patent Application Publication
(10) Pub. No.: US 2006/0228556 A1
(43) Pub. Date: Oct. 12, 2006

(54) Electrodepositable coating compositions and methods for their production

(76) Inventor: David R. Fenn, Allison Park, PA (US)

Correspondence Address: PPG Industries, Inc.;Intellectual Property Department, One PPG Place, Pittsburgh, PA, 15272, US

(21) Appl. No.: 11/101,802

(22) Filed: Apr. 8, 2005

(51) Int. Cl. C08G 59/40; B32B 27/40

(52) U.S. Cl. 428/411.1; 528/107; 428/423.1

(57) ABSTRACT

Methods are disclosed for producing aqueous dispersions comprising a resinous phase dispersed in a dispersing medium, wherein the resinous phase includes an active hydrogen-containing film-forming resin Also disclosed are electrodepositable coating compositions that include such dispersions, electroconductive substrates at least partially coated with such compositions, and methods for at least partially coating electroconductive substrates with such compositions.

### FIELD OF THE INVENTION

The present invention relates to electrodepositable coating compositions, such as photodegradation-resistant compositions, that include a high molecular weight resinous phase and methods for producing aqueous dispersions that can be included in such compositions. The present invention is also directed to electroconductive substrates at least partially coated with such a composition, photodegradation-resistant multi-layer coatings comprising a primer layer formed from such a composition, and methods for at least partially coating electroconductive substrates with such a composition.

### BACKGROUND OF THE INVENTION

Electrodepositable coating compositions are often used to provide coatings for corrosion protection of metal substrates, such as those used in the automobile industry. Electrodeposition processes often provide higher paint utilization, outstanding corrosion protection, low environmental contamination, and/or a highly automated process relative to non-electrophoretic coating methods.

In the electrodeposition process, an article having an electroconductive substrate, such as an automobile body or body part, is immersed into a bath of a coating composition of an aqueous emulsion of film forming polymer, the electroconductive substrate serving as a charge electrode in an electrical circuit comprising the electrode and an oppositely charged counter-electrode. An electrical current is passed between the article and a counter-electrode in electrical contact with the aqueous, emulsion, until a coating having the desired thickness is deposited on the article. In a cathodic electrocoating process, the article to be coated is the cathode and the counter-electrode is the anode.

Electrodepositable coating compositions are often used to form corrosion resistant primer coatings. Historically, electrodepositable primer coating compositions, such as those used in the automotive industry, have been corrosion-resistant epoxy-based compositions crosslinked with aromatic isocyanates. Such compositions, if exposed to ultraviolet energy, such as sunlight, can undergo photodegradation. In some cases, therefore, a primer-surfacer has been applied directly to such a cured electrodeposited coating prior to application of one or more topcoats. The primer-surfacer can provide a variety of properties to the coating system, including protection of the electrodeposited coating from photodegradation. Alternatively, one or more top coats can be applied directly to such cured electrodeposited coatings and, in such instances, the top coat(s) are formulated such that the top coat provides sufficient protection of the electrodeposited coating from photodegradation If the top coat(s) do not provide sufficient protection, photodegradation of the electrodeposited coatings can occur, causing delamination of the top coat(s) from the cured electrodeposited primer coatings.

More recently, electrodepositable primer coating compositions have been disclosed that retard photodegradation and delamination of the subsequently applied, top coat(s) independent of the presence of a primer-surfacer or the top coat composition(s). For example, U.S. Patent Application Publication 2003/0054193A1 discloses photodegradation resistant electrodepositable coating compositions that comprise a resinous phase dispersed in an aqueous medium, wherein the resinous phase comprises: (1) one or more ungelled, active hydrogen-containing, cationic amine salt group containing resins which are electrodepositable on a cathode, wherein the amine salt groups are derived from certain pendent and/or terminal amine groups, and (2) one or more at least partially blocked aliphatic polyisocyanate curing agents. In addition, U.S. Patent Application Publication 2003/0098238 A1 discloses photodegradation resistant electrodepositable coating compositions that comprise a resinous phase dispersed in an aqueous medium. The resinous phase comprises: (1) one or more ungelled, active hydrogen-containing cationic sulfonium salt group-containing resins which are electrodepositable on a cathode, and (b) one or more curing agents comprising cationic groups or, groups which are capable of forming cationic groups.

In certain applications, such as, for example, where certain appearance properties, such as oil spot resistance, may be important, there is a need to formulate electrodepositable coating compositions, including photodegradation-resistant compositions, which include a film-forming resin of high molecular weight. The manufacture of such compositions, however, can present difficulties. For example, high molecular weight resins tend to be extremely viscous, which can make the dispersion process difficult. Moreover, there is often a substantial risk of gelation when making electrodepositable coating compositions that include film-forming resins having a high molecular weight.

### SUMMARY OF THE INVENTION

In one respect, the present invention is directed to methods for making stable, aqueous dispersions comprising a high molecular weight resinous phase dispersed in a dispersing medium. These methods comprise (a) forming a stable dispersion in the dispersing medium of an ungelled resinous phase comprising an active hydrogen-containing, film-forming resin; and (b) chain extending the active hydrogen-containing film-forming resin in the stable dispersion to form the stable, aqueous dispersion comprising the high molecular weight resinous phase dispersed in the dispersing medium.

In another respect, the present invention is directed to curable, electrodepositable coating compositions that comprise a resinous phase dispersed in an aqueous medium. In these compositions, the resinous phase comprises (a) an at least partially blocked aliphatic polyisocyanate curing agent, and (b) an active hydrogen-containing, cationic amine salt group-containing resin, which is electrodepositable on a cathode, wherein the amine salt groups are derived from pendant and/or terminal amino salt groups having the structure: 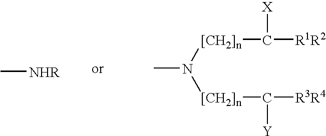
wherein R represents H or C₁ to C₁₈ alkyl; R¹, R², R³, and R⁴ are the same or different, and each independently represents H or C₁ to C₄ alkyl; n is an integer having a value ranging from 1 to 11, such as 1 to 5 or, in some cases, 1 to 2; and X and Y can be the same or different, and each independently represents a hydroxyl group or an amino group. In these compositions, the resinous phase has a Z-average molecular weight of at least 200,000.

In other respects, the present invention is directed to electroconductive substrates at least partially coated with such a composition, photodegradation-resistant multi-layer coatings comprising a primer layer formed from such a composition, and methods for at least partially coating electroconductive substrates with such a composition.

### DETAILED DESCRIPTION OF EMBODIMENTS OF THE INVENTION

For purposes of the following detailed description, it is to be understood that the invention may assume various alternative variations and step sequences, except where expressly specified to the contrary. It is also to be understood that the specific devices, if any, described in the following specification are simply exemplary embodiments of the invention. Hence, any specific dimensions or other physical characteristics related to the embodiments disclosed herein are not to be considered as limiting. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples, are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

It should also be understood that, in this application, use of the singular includes the plural unless specifically stated otherwise. For example, and without limitation, this application refers to stable dispersions comprising a resinous phase comprising “an active hydrogen-containing, film-forming resin.” Such references to “an active hydrogen-containing, film-forming resin” is meant to encompass dispersions comprising one such resin as well as dispersions that comprise more than one such resin, such as dispersions that comprise two such resins. In addition, in this application, the use of “or” means “and/or” unless specifically stated otherwise, even though “and/or” may be explicitly used in certain instances.

In certain embodiments, the present invention is directed to methods for making stable, aqueous dispersions that comprise a high molecular weight resinous phase dispersed in a dispersing medium. These methods comprise (a) forming a stable dispersion in the dispersing medium of an ungelled resinous phase comprising an active hydrogen-containing, film-forming resin; and (b) chain extending the active hydrogen-containing film-forming resin in the stable dispersion to form the stable, aqueous dispersion comprising the high molecular weight resinous phase dispersed in the dispersing medium. Such aqueous dispersions are suitable for use in electrodepositable coating compositions. These methods of the present invention permit the production of electrodepositable coating compositions that include a high molecular weight resinous phase dispersed in a dispersing medium while reducing or eliminating the need to deal with high viscosity film-forming resins prior to their dispersion in the dispersing medium. Moreover, these methods can reduce the risk of gelation because the molecular weight of the resinous phase is increased in the dispersion.

As indicated, in certain embodiments, the present invention is directed to methods for making stable, aqueous dispersions comprising a high molecular weight resinous phase. In addition, in certain embodiments, the present invention is directed to electrodepositable coating compositions that comprise such dispersions. As used herein, the term “electrodepositable coating composition” refers to a composition that is capable of being deposited onto a conductive substrate under the influence of an applied electrical potential.

Certain methods of the present invention comprise the step of forming a stable dispersion in a dispersing medium of an ungelled resinous phase comprising an active hydrogen-containing film-forming resin. As used herein, the term “dispersion” refers to a two-phase transparent, translucent or opaque resinous system in which the resin is in the dispersed phase and the dispersing medium is in the continuous phase. As used herein, the term “stable dispersion” refers to a dispersion that does not gel, flocculate or precipitate at a temperature of 25° C. for at least 60 days, or, if some precipitation does occur, the precipitate can be redispersed upon agitation.

As used herein, the term “ungelled” refers to resins that are substantially free of crosslinking and have an intrinsic viscosity when dissolved in a suitable solvent as determined, for example, in accordance with ASTM-D1795 or ASTM-D4243. The intrinsic viscosity of a resin, or mixture of resins, is an indication of its molecular weight. A gelled resin, on the other hand, since it is of essentially infinitely high molecular weight, will have an intrinsic viscosity too high to measure.

As used herein, the term “active hydrogen-containing” refers to polymers that comprise active hydrogens as reaction sites. The term “active hydrogen” refers to those groups that are reactive with isocyanates as determined by the Zerewitnoff test as is described in the JOURNAL OF THE AMERICAN CHEMICAL SOCIETY, Vol. 49, page 3181 (1927). In certain embodiments, the active hydrogens are derived from hydroxyl groups, primary amine groups and/or secondary amine groups.

As used herein, the term “film-forming resin” refers to resins that can form a self-supporting continuous film on at least a horizontal surface of a substrate upon removal of any diluents or carriers present in the composition or upon curing at ambient or elevated temperature.

In certain embodiments, the active hydrogen-containing film-forming resin comprises a cationic polymer. Cationic polymers suitable for use in the dispersions made in accordance with certain methods of the present invention can include any of a number of cationic polymers well known in the art so long as the polymers are dispersible, i.e. adapted to be solubilized, dispersed, or emulsified in the dispersing medium, such as water. As used herein, the term “cationic polymer” refers to polymers that comprise cationic functional groups that impart a positive charge. Functional groups that can render a cationic polymer dispersible in water, which are suitable in the present invention, include sulfonium groups and amine groups. As used herein, the term “polymer” refers to oligomers and both homopolymers and copolymers.

Non-limiting examples of such cationic film-forming resins include active hydrogen-containing, cationic polymers selected from one or more of a polyepoxide polymer, an acrylic polymer, a polyurethane polymer, a polyester polymer, mixtures thereof, and copolymers thereof, including graft copolymers thereof. In certain embodiments, the active hydrogen-containing film-forming resin comprises an acrylic polymer.

Suitable polyepoxides include any of a variety of polyepoxides known in the art. Examples of such polyepoxides include those having a 1,2-epoxy equivalency greater than one, and often two; that is, polyepoxides that have on average two epoxide groups per molecule. Such polyepoxide polymers can include the polyglycidyl ethers of cyclic polyols, for example polyhydric phenols, such as Bisphenol A. These polyepoxides can be prepared by etherification of polyhydric phenols with an epihalohydrin or dihalohydrin such as epichlorohydrin or dichlorohydrin in the presence of alkali. Nonlimiting examples of suitable polyhydric phenols include 2,2-bis-(4-hydroxyphenyl)propane, 1,1-bis-(4-hydroxyphenyl)ethane, 2-methyl-1,1-bis-(4-hydroxyphenyl)propane, 2,2-(4-hydroxy-3-tertiarybutylphenyl)propane, and bis-(2-hydroxynaphthyl)methane.

Besides polyhydric phenols, other cyclic polyols can be used to prepare the polyglycidyl ethers of cyclic polyol derivatives. Examples of such cyclic polyols include alicyclic polyols, such as cycloaliphatic polyols, for example, 1,2-cyclohexanediol, 1,4-cyclohexanediol, 1,2-bis-(hydroxymethyl)cyclohexane, 1,3-bis-(hydroxymethyl)cyclohexane and hydrogenated bisphenol A.

Polyepoxides can be chain-extended with a polyether or a polyester polyol. Examples of suitable polyether polyols and conditions for chain extension are disclosed in U.S. Pat. No. 4,468,307. Examples of polyester polyols for chain extension are disclosed in U.S. Pat. No. 4,148,772.

Other suitable polyepoxides can be produced similarly from novolak resins or similar polyphenols. Such polyepoxide resins are described in U.S. Pat. Nos. 3,663,389; 3,984,299; 3,947,338; and 3,947,339. Additional suitable polyepoxide resins include those described in U.S. Pat. Nos. 4,755,418, 5,948,229 and 6,017,432.

Suitable acrylic polymers include, for example, copolymers of one or more alkyl esters of acrylic acid or methacrylic acid, optionally together with one or more other polymerizable ethylenically unsaturated monomers. Suitable alkyl esters of acrylic acid or methacrylic acid include methyl methacrylate, ethyl methacrylate, butyl methacrylate ethyl acrylate, butyl acrylate and 2-ethyl hexyl acrylate. Suitable other copolymerizable ethylenically unsaturated monomers include nitriles, such as acrylonitrile and methacrylonitrile, vinyl and vinylidene halides, such as vinyl chloride and vinylidene fluoride, and vinyl esters, such as vinyl acetate. Acid and anhydride functional ethylenically unsaturated monomers, such as acrylic acid, methacrylic acid or anhydride, itaconic acid, maleic acid or anhydride, or fumaric acid may be used. Amide functional monomers including, acrylamide, methacrylamide, and N-alkyl substituted (meth)acrylamides are also suitable. Vinyl aromatic compounds, such as styrene and vinyl toluene can also be used in certain cases.

Functional groups, such as hydroxyl and amino groups, can be incorporated into the acrylic polymer by using functional monomers, such as hydroxyalkyl acrylates and methacrylates or aminoalkyl acrylates and methacrylates. Epoxide functional groups (for conversion to cationic salt groups) may be incorporated into the acrylic polymer by using functional monomers, such as glycidyl acrylate and methacrylate, 3,4-epoxycyclohexylmethyl(meth)acrylate, 2-(3,4-epoxycyclohexyl)ethyl(meth)acrylate, or allyl glycidyl ether. Alternatively, epoxide functional groups may be incorporated into the acrylic polymer by reacting carboxyl groups on the acrylic polymer with an epihalohydrin or dihalohydrin, such as epichlorohydrin or dichlorohydrin.

Suitable acrylic polymers can be prepared by traditional free radical initiated polymerization techniques, such as solution polymerization techniques, as known in the art using suitable catalysts, which include organic peroxides and azo type compounds, and optionally chain transfer agents, such as alpha-methyl styrene dimer and tertiary dodecyl mercaptan. Additional suitable acrylic polymers include those resins described in U.S. Pat. Nos. 3,455,806 and 3,928,157.

Suitable polyurethane polymers include, for example, polymeric polyols which are prepared by reacting polyester polyols or acrylic polyols, such as those mentioned above, with a polyisocyanate such that the hydroxyl/isocyanate equivalent ratio is greater than 1:1 so that free hydroxyl groups are present in the product. Smaller polyhydric alcohols, such as those disclosed above for use in the preparation of the polyester, may also be used in place of or in combination with the polymeric polyols.

Additional examples of suitable polyurethane polymers include the polyurethane, polyurea, and poly(urethane urea) polymers prepared by reacting polyether polyols and/or polyether polyamines with polyisocyanates. Such polyurethane polymers are described in U.S. Pat. No. 6,248,225.

Hydroxyl functional tertiary amines, such as N,N-dialkylalkanolamines and N-alkyl dialkanolamines, may be used in combination with the other polyols in the preparation of the polyurethane. Examples of suitable tertiary amines include those N-alkyl dialkanolamines disclosed in U.S. Pat. No. 5,483,012 at column 3, lines 49-63.

Epoxide functional groups may be incorporated into the polyurethane by methods well known in the art. For example, epoxide groups can be incorporated by reacting hydroxyl groups on the polyurethane with an epihalohydrin or dihalohydrin, such as epichlorohydrin or dichlorohydrin, in the presence of alkali.

Sulfonium group-containing polyurethanes are also suitable and can also be made by at least partial reaction of hydroxy-functional sulfide compounds, such as thiodiglycol and thiodipropanol, which results in incorporation of sulfur into the backbone of the polymer. The sulfur-containing polymer is then reacted with a monofunctional epoxy compound in the presence of acid to form the sulfonium group. Appropriate monofunctional epoxy compounds include ethylene oxide, propylene oxide, glycidol, phenylglycidyl ether, and CARDURA® E, available from Resolution Performance Products.

Suitable polyesters can be prepared in a known manner by condensation of polyhydric alcohols and polycarboxylic acids. Suitable polyhydric alcohols include, for example, ethylene glycol, propylene glycol, butylene glycol, 1,6-hexylene glycol, neopentyl glycol, diethylene glycol, glycerol, trimethylol propane, and pentaerythritol. Examples of polycarboxlic acids suitable for use in preparing the polyester include succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used.

In certain embodiments, the polyesters contain a portion of free hydroxyl groups (resulting from the use of excess polyhydric alcohol and/or higher polyols during preparation of the polyester) that are available for cure reactions. Epoxide functional groups may be incorporated into the polyester by reacting carboxyl groups on the polyester with an epihalohydrin or dihalohydrin, such as epichlorohydrin or dichlorohydrin.

Amino groups can be incorporated into the polyester polymer by reacting epoxy functional groups of the polymer with a hydroxyl containing tertiary amine, for example, N,N-dialkyl alkanolamines and N-alkyl dialkanolamines. Specific examples of suitable tertiary amines include those N-alkyl dialkanolamines disclosed in U.S. Pat. No. 5,483,012, at column 3, lines 49-63.Suitable polyesters include those disclosed in U.S. Pat. No. 3,928 ,157.

Sulfonium group-containing polyesters are also suitable. Sulfonium salt groups can be introduced by the reaction of an epoxy group-containing polymer of the type described above with a sulfide in the presence of an acid; as described in U.S. Pat. Nos. 3,959,106 and 4,715,898. Sulfonium groups can be introduced onto the polyester backbones described using similar reaction conditions.

In certain embodiments, the active hydrogen-containing film forming resin comprises cationic amine salt groups that are derived from pendant and/or terminal amino group. By “pendant and/or terminal” is meant that primary, secondary, and/or tertiary amino groups are present as a substituent which is pendant from or in the terminal position of the polymeric backbone, or, alternatively, is an end-group substituent of a group which is pendant and/or terminal from the polymer backbone. In other words, the amino groups from which the cationic amine salt groups are derived are not within the polymeric backbone.

The pendant and/or terminal amino groups can have the following structures (I) or (II) 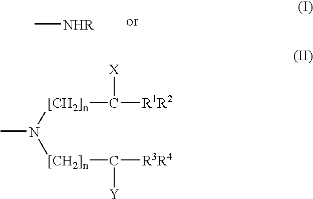
wherein R represents H or C₁ to C₁₈ alkyl R¹, R², R³, and R⁴ are the same or different, and each independently represents H or C₁ to C₄ alkyl; n is an integer having a value ranging from 1 to 11, such as 1 to 5 or, in some cases 1 to 2; and X and Y can be the same or different, and each independently represents a hydroxyl group or an amino group.

By “alkyl” is meant alkyl and aralkyl, cyclic or acyclic, linear or branched monovalent hydrocarbon groups. The alkyl groups can be unsubstituted or substituted with one or more heteroatoms, for example, non-carbon, non-hydrogen atoms, such as one or more oxygen, nitrogen or sulfur atoms.

The pendant and/or terminal amino groups represented by structures (I) and (II) above can be derived from a compound selected from ammonia, methylamine, diethanolamine, diisopropanolamine, N-hydroxyethyl ethylenediamine, diethylenetriamine, dipropylenetriamine, bis-hexamethylenetriamine and mixtures thereof. One or more of these compounds is reacted with one or more of the above described polymers, for example, a polyepoxide polymer, where the epoxy groups are ring-opened via reaction with a polyamine, thereby providing terminal amino groups and secondary hydroxyl groups.

In certain embodiments, the cationic salt group-containing polymer contains amine salt groups which are derived from one or more pendant and/or terminal amino groups having the structure (II) above, such that when included in an electrodepositable coating composition that is electrodeposited and cured, at least two electron-withdrawing groups (as described in detail below) are bonded in the beta-position relative to substantially all of the nitrogen atoms present in the cured electrodeposited coating. In certain embodiments, when such an electrodepositable coating composition is electrodeposited and cured, three electron-withdrawing groups are bonded in the beta-position relative to substantially all of the nitrogen atoms present in the cured electrodeposited coating. By “substantially all”, of the nitrogen atoms present in the cured electrodeposited coating is meant at least 65 percent, such as at least 90 percent, of all nitrogen atoms present in the cured electrodeposited coating which are derived from the amine used to form the cationic amine salt groups.

As discussed below, the electron-withdrawing groups to which reference is made herein are formed by the reaction of a curing agent with the pendant and/or terminal hydroxyl and/or amino groups represented by X and Y in structure (II) which are bonded in the beta-position relative to the nitrogen atom depicted in this structure. The amount of free or unbound amine nitrogen present in a cured free film of the electrodepositable composition can be determined as follows. The cured free coating film can be cryogenically milled and dissolved with acetic acid then titrated potentiometrically with acetous perchloric acid to determine the total base content of the sample. The primary amine content of the sample can be determined by reaction of the primary amine with salicylaldehyde to form an untitratable azomethine. Any unreacted secondary and tertiary amine then can be determined by potentiometric titration with perchloric acid. The difference between the total basicity and this titration represents the primary amine. The tertiary amine content of the sample can be determined by potentiometric titration with perchloric acid after reaction of the primary and secondary amine with acetic anhydride to form the corresponding amides.

In certain embodiments, the terminal amino groups have the structure (II) Where both X and Y comprise primary amino groups, e.g., the amino group is derived from diethylenetriamine, dipropylenetriamine, and/or bis-hexamethylenetriamine. In this instance, prior to reaction with the polymer, the primary amino groups can be blocked, for example, by reaction with a ketone such as methylethyl ketone, to form the diketimine. Such ketimines are described in U.S. Pat. No. 4,104,147, column 6, line 23 to column 7, line 23. The ketimine groups can decompose upon dispersing the amine epoxy reaction product in water, thereby providing free primary amine groups as curing reaction sites.

Minor amounts (e.g., an amount which would represent less than or equal to 5 percent of total amine nitrogen present in the composition) of amines such as mono, di, and trialkylamines and mixed aryl-alkyl amines which do not contain hydroxyl groups, or amines substituted with groups other than hydroxyl, may be included provided that the inclusion of such amines does not negatively affect the photodegradation resistance of the cured electrodeposited coating. Specific examples include monoethanolamine, N-methylethanolamine, ethylamine, methylethylamine, triethylamine, N-benzyldimethylamine, dicocoamine and N,N-dimethylcyclohexylamine.

In certain embodiments, the reaction of the above-described amines with epoxide groups on the polymer takes place upon mixing of the amine and polymer. The amine may be added to the polymer or vice versa. The reaction can be conducted neat or in the presence of a suitable solvent such as methyl isobutyl ketone, xylene, or 1-methoxy-2-propanol. The reaction is generally exothermic and cooling may be desired. However, heating to a moderate temperature of about 50° C. to 150° C. may be done to hasten the reaction.

In certain embodiments, the active hydrogen-containing, cationic salt group-containing polymer is prepared from components selected so as to maximize the photodegradation resistance of the polymer and the coating formed from the resulting electrodepositable composition. Though not intending to be bound by any theory, it is believed that photodegradation resistance (i.e., resistance to visible and ultraviolet degradation) of the cured electrodeposited coating can be correlated with the location and nature of nitrogen-containing cationic groups used for dispersion of the active hydrogen-containing, cationic amine salt group-containing resin.

In certain embodiments, the amines from which the pendant and/or terminal amino groups are derived comprise primary and/or secondary amine groups such that the active hydrogens of said amines will be consumed by reaction with a polyisocyanate during chain extension and/or cure to form urea groups or linkages.

In certain embodiments, the stable dispersion comprises a resinous phase comprising a mixture of at least two different ungelled, active hydrogen containing film-forming resins. In some cases, such dispersions are formulated with an additional ionic film forming polymer, such as a cationic salt group containing film forming polymer that is substantially free of diene-derived polymeric material. Suitable resins include high throwpower amine salt group-containing resins which are the acid-solubilized reaction products of polyepoxides and primary and secondary amines such as are described in U.S. Pat. No. 4,031,050 at column 3, line 20 to column 5, line 8, this portion of which is incorporated herein by reference. In some cases, these amine salt group containing resins are used in combination with a blocked isocyanate curing agent such as those discussed more fully below. In addition, such dispersions may include low throwpower resins such as cationic acrylic resins, such as those described in U.S. Pat. No. 3,455,806 at column 2, line 36 to column 4, line 2 and U.S. Pat. No. 3,928,157 at column 2, line 29 to column 3, line 21, these portions of both of which are incorporated herein by reference.

Besides amine salt group-containing resins, quaternary ammonium salt group-containing resins can also be employed. Examples of these resins are those which are formed from reacting an organic polyepoxide with a tertiary amine acid salt. Such resins are described in U.S. Pat. No. 3,962,165 at column 2, line 3 to column 10, line 64; U.S. Pat. No. 3,975,346 at column 1, line 62 to column 14, line 9 and U.S. Pat. No. 4,001,156 at column 1, line 58 to column 14, line 43, these portions of which are incorporated herein by reference. Examples of other suitable cationic resins include ternary sulfonium salt group-containing resins, such as those described in U.S. Pat. No. 3,793,278 at column 1, line 46 to column 5, line 25, this portion of which is incorporated herein by reference. Also, cationic resins which cure via a transesterification mechanism, such as described in European Patent Application No. 12463 A1 at page 1, line 29 to page 10, line 40, this portion of which is incorporated herein by reference, can also be employed.

Therefore, in certain embodiments, the stable dispersion comprises a resinous phase comprising a mixture of at least two ungelled, active hydrogen-containing film-forming resins. In certain embodiments, such dispersions comprise a mixture of a cationic polyepoxide polymer and a cationic acrylic polymer. Where such mixtures are used, the polyepoxide polymer can be present in the dispersion in an amount ranging from 5 to 80, such as 10 to 60 or, in some cases, 10 to 40 weight percent, based on total weight of resin solids present in the composition.

In certain embodiments, the stable dispersion comprises a resinous phase comprising a curing agent adapted to react with the active hydrogen groups of the active hydrogen-containing film-forming resin(s). In certain embodiments, the curing agent comprises an at least partially blocked polyisocyanate, such as an aliphatic polyisocyanate, an aromatic polyisocyanate, or a mixture of the two. In certain embodiments, the curing agent comprises an at least partially blocked aliphatic polyisocyanate.

Suitable at least partially blocked aliphatic polyisocyanates include, for example, fully blocked aliphatic polyisocyanates, such as those described in U.S. Pat. No. 3,984,299 at col. 1 line 57 to col. 3 line 15, or partially blocked aliphatic polyisocyanates that are reacted with the polymer backbone, such as is described in U.S. Pat. No. 3,947,338 at col. 2 line 65 to col. 4 line 30. By “blocked” is meant that the isocyanate groups have been reacted with a compound such that the resultant blocked isocyanate group is stable to active hydrogens at ambient temperature but reactive with active hydrogens at elevated temperatures usually between 90° C. and 20° C. In certain embodiments, the polyisocyanate curing agent is a fully blocked polyisocyanate with substantially no free isocyanate groups.

In certain embodiments, the polyisocyanate comprises a diisocyanate, though, in other embodiments, higher polyisocyanates are used in lieu of or in combination with diisocyanates. Examples of aliphatic polyisocyanates suitable for use as curing agents include cycloaliphatic and araliphatic polyisocyanates, such as 1,6-hexamethylene diisocyanate, isophorone diisocyanate, bis-(isocyanatocyclohexyl)methane, polymeric 1,6-hexamethylene diisocyanate, trimerized isophorone diisocyanate, norbornane diisocyanate and mixtures thereof. In certain embodiments of the present invention, the curing agent comprises a fully blocked polyisocyanate selected from a polymeric 1,6-hexamethylene diisocyanate, isophorone diisocyanate, and mixtures thereof. In other embodiments of the present invention, the polyisocyanate curing agent comprises a fully blocked trimer of hexamethylene. diisocyanate available as Desmodur N3300® from Bayer Corporation.

In certain embodiments, the polyisocyanate curing agent is at least partially blocked with at least one blocking agent selected from a 1,2-alkane diol, for example 1,2-propanediol; a 1,3-alkane diol, for example 1,3-butanediol; a benzylic alcohol, for example, benzyl alcohol; an allylic alcohol, for example, allyl alcohol; caprolactam; a dialkylamine, for example dibutylamine; and mixtures thereof. In certain embodiments, the polyisocyanate curing agent is at least partially blocked with at least one 1,2-alkane diol having three or more carbon atoms, for example 1,2-butanediol.

In certain embodiments, the blocking agent comprises other well known blocking agents such as aliphatic, cycloaliphatic, or aromatic alkyl monoalcohols or phenolic compounds, including, for example, lower aliphatic alcohols, such as methanol, ethanol, and n-butanol; cycloaliphatic alcohols, such as cyclohexanol; aromatic-alkyl alcohols, such as phenyl carbinol and methylphenyl carbinol, and phenolic compounds, such as phenol itself and substituted phenols wherein the substituents do not affect coating operations, such as cresol and nitrophenol. Glycol ethers and glycol amines may also be used as blocking agents. Suitable glycol ethers include ethylene glycol butyl ether, diethylene glycol butyl ether, ethylene glycol methyl ether and propylene glycol methyl ether. Other suitable blocking agents include oximes, such as methyl ethyl ketoxime, acetone oxime and cyclohexanone oxime.

In certain embodiments, the at least partially blocked polyisocyanate curing agent is present in an amount ranging from 80 to 20 percent, such as from 75 to 30 percent, or, in some cases, from 50 to 30 percent, with the percentages being weight percents based on the total combined weight of resin solids of the active hydrogen-containing film-forming resin(s) and the curing agent.

In certain embodiments, the ungelled resinous phase (including the one or more ungelled, active hydrogen-containing film forming resins and curing agent) has a Z-average molecular weight (Mz), as obtained by gel permeation chromatography carried out in dimethylformamide (DMF) using polystyrene standards in an art-recognized manner, of 100,000 to 600,000, such as 200,000 to 500,000. Methods for controlling the molecular weight of the active hydrogen-containing film-forming resin will be apparent to those skilled in the art. For example, if the active hydrogen-containing film-forming resin comprises an acrylic resin made by solution polymerization as described earlier, the molecular weight of such a resin can be controlled by controlling the initiator, solvent, and/or chain transfer agent type and/or levels the ratio of amine to epoxy groups and/or the reaction time and/or temperature. If the active hydrogen-containing film-forming resin comprises the reaction product of a polyepoxide-polymer with an amine, as described earlier, the molecular weight of the resin may be controlled by controlling the reaction time and/or temperature, the ratio of amine to epoxy groups, or the type of amine or ketimine.

As previously indicated, according to certain methods of the present invention a stable dispersion is formed wherein the resinous phase is dispersed in a dispersing medium. In certain embodiments, the dispersing medium comprises water. Besides water, the dispersing medium may contain a coalescing solvent. Useful coalescing solvents include hydrocarbons, alcohols, esters, ethers and ketones. In some cases, the coalescing solvents include alcohols, polyols and ketones. Specific examples of suitable coalescing solvents include isopropanol, butanol, 2-ethylhexanol, isophorone, 2-methoxypentanone, ethylene and propylene glycol and the monoethyl, monobutyl and monohexyl ethers of ethylene glycol. In certain embodiments, the amount of coalescing solvent is from 0.01 to 25 percent by weight, such as from 0.05 to 5 percent by weight, based on total weight of the dispersing medium. In certain embodiments, the average particle size of the resinous phase in the dispersing medium is less than 1.0 micron, such as less than 0.5 micron, such as less than 0.15 micron.

In certain embodiments, the concentration of the resinous phase in the dispersing medium is at least 1, such as from 2 to 60 percent by weight, based on total weight of the dispersion.

In certain embodiments, the active hydrogen-containing film-forming resin, is, prior to dispersion in the dispersing medium, at least partially neutralized, for example, by treating with an acid to form a water-dispersible resin. As previously indicated, such resins may comprise cationic functional groups that render the resin dispersible in water, such as sulfonium groups and amine groups. Non-limiting examples of suitable acids include organic and inorganic acids such as formic acid, acetic acid, lactic acid, phosphoric acid, dimethylolpropionic acid, and sulfamic acid. Mixtures of acids can be used. The extent of neutralization varies with the particular reaction product involved. However, sufficient acid should be used to disperse the film-forming resin(s) in water. In certain cases, the amount of acid used provides at least 30 percent of the total theoretical neutralization. Excess acid may also be used beyond the amount required for 100 percent total theoretical neutralization.

The extent of cationic salt group-formation should be such that when the film-forming resin is mixed with the other ingredients, a stable dispersion of the film-forming resin(s) will form. Moreover in certain embodiments, the dispersion is of sufficient cationic character that the dispersed particles migrate toward and electrodeposit on a cathode when an electrical potential is set up between an anode and a cathode immersed in the dispersion.

In certain embodiments, the active-hydrogen containing film-forming resin (or mixture of two or more thereof) contains, prior to chain extension, from 0.1 to 3.0, such as 0.4 to 2.0, or, in some cases, 0.8 to 1.4 millequivalents of cationic salt group per gram of polymer solids.

The dispersion step may be accomplished by combining the neutralized or partially neutralized resin with the dispersing medium. Neutralization and dispersion can be accomplished in one step by combining the resin and the dispersing medium. The resin (or its salt) can be added to the dispersing medium or the dispersing medium can added to the resin (or its salt). In certain embodiments, the pH of the dispersion is within the range of 5 to 9. Suitable conditions for forming such stable dispersions include those set forth in the Examples.

As previously indicated, certain methods of the present invention comprise the step of chain extending the active hydrogen-containing film-forming resin in the stable dispersion to form a stable dispersion of the high molecular weight resinous phase dispersed in the dispersing medium. In the embodiments of the present invention wherein the dispersion comprises two or more active hydrogen-containing film-forming resins, the methods of the present invention comprise the step of chain extending at least one of those resins in the dispersion.

As used herein, the term “high molecular weight” refers to a resinous phase (which, as discussed earlier, may include one or more active hydrogen film-forming resins and a curing agent) that has a Mz, obtained as described previously, that is greater than the Mz of the ungelled resinous phase from which the high molecular weight resinous phase is formed. For example, in certain embodiments of the present invention wherein the dispersion comprises one active-hydrogen containing film-forming resin, the high molecular weight resinous phase has a Mz at least 25% greater, or, in some cases, at least 30% greater, or, in yet other cases, at least 50% greater than the resinous phase from which the high molecular weight resinous phase is formed. In other embodiments wherein the dispersion comprises two or more active hydrogen-containing film-forming resins, the high molecular weight resinous phase has a Mz at least 5% greater, or, in some cases, at least 10% greater, or, in yet other cases, at least 20% greater than the ungelled resinous phase from which the high molecular weight resin is formed. Moreover, in certain embodiments of the present invention wherein the dispersion comprises one ungelled active hydrogen-containing film-forming resin, the high molecular weight resinous phase has a Mz of at least 200,000, or, in some cases, the Mz is from 200,000 to 2,000,000, such as from 500,000 to 1,500,000, from 600,000 to 1,300,000, or, in yet other cases, from 600,000 to 1,000,000. In other embodiments wherein the dispersion comprises two or more active hydrogen-containing film-forming resins, the high molecular weight resinous phase has a Mz of at least 150,000, or, in some cases, the Mz is from 200,000 to 2,000,000,such as from 300,000 to 1,500,000,or from 400,000 to 1,300,000.

In certain embodiments, chain extension of the active hydrogen-containing film-forming resin in the stable dispersion is accomplished by reacting the resin with a reactant comprising reactive groups reactive with the active hydrogen groups of the resin. In certain embodiments, the reactant comprises an unblocked polyisocyanate, such as an aliphatic polyisocyanate, aromatic polyisocyanate, or a mixture of the two. Suitable polyisocyanates include, for example, m-tetramethylxylene diisocyanate (“m-TMDI”), hexamethylene diisocyanate trimer (“HMDI”), and isophorone diisocyanate trimer (“IPDI”). In certain embodiments, such a reactant is present in an amount of 0.1 to 10 percent by weight, such as 0.5 to 5 percent by weight, or, in some cases, 0.5 to 2 percent by weight, based on the total weight of resin solids in the dispersion.

In certain embodiments, chain extension of the active hydrogen-containing film-forming resin in the stable dispersion takes place in the presence of a catalyst. Suitable catalysts include, for example organotin compounds, such as dibutyltin oxide, dioctyltin oxide, dibutyltin dilaurate, dibutyltin acetate, and the like. In certain embodiments, the catalyst is present in an amount of 0.01 to 5.0 percent by weight, such as 0.05 to 1.0 percent by weight, based on the total weight of resin solids in the dispersion.

The time and temperature of the chain extension reaction will depend, as will be appreciated by those skilled in the art, on the ingredients selected and, in some cases, the scale of the reaction. Suitable conditions for chain extending the active hydrogen-containing film-forming resin in the stable dispersion to form a stable dispersion, in the dispersing medium, of a high molecular weight resinous phase include those conditions set forth in the Examples.

In certain embodiments, the active hydrogen-containing film-forming resin contains, after chain extension, from 0.1 to 3.0, such as from 0.4 to 2.0, or, in some cases, 6.6. to 1.2 millequivalents of cationic salt groups per gram of resin solids.

In certain embodiments, particularly where the active hydrogen-containing film forming resin-comprises cationic amine salt groups that are derived from pendant and/or terminal amino groups, as described earlier, the active hydrogen-containing film-forming resin comprises, after chain extension, fewer cationic salt groups per gram of resin than the resin contained prior to chain extension, due to the formation of urea linkages as described previously. For example, in certain embodiments, the active hydrogen-containing film-forming resin comprises from 0.02 to 0.3, such as 0.04 to 0.15, fewer millequivalents of cationic salt groups per gram of resin after chain extension than prior to chain extension.

As should be appreciated from the foregoing description, the present invention is also directed to electrodepositable coating compositions comprising such dispersions. Thus, in certain embodiments, the present invention is directed to curable, electrodepositable coating compositions that comprise a resinous phase dispersed in an aqueous medium. In these compositions, the resinous phase comprises (a) an at least partially blocked aliphatic-polyisocyanate curing agent, and (b) an active hydrogen-containing, cationic amine salt group-containing resin, which is electrodepositable on a cathode, wherein the amine salt groups are derived from pendant and/or terminal amino salt groups having the structure: 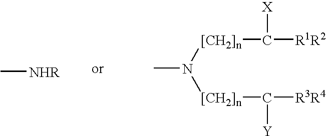
wherein R represents H or C₁ to C₁₈ alkyl; R¹, R², R³, and R⁴ are the same or different, and each independently represents H or C₁ to C₄ alkyl; n is an integer having a value ranging from 1 to 11, such as 1 to 5 or, in some cases 1 to 2; and X and Y can be the same or different, and each independently represents a hydroxyl group or an amino group. In these compositions the resinous phase has a Z-average molecular weight of at least 200,000.

In certain embodiments, the active hydrogen-containing film-forming resin is present in an amount of at least 10 percent by weight, such as at least 20 by weight, or, in some cases, at least 25 percent by weight, based on the total weight of resin solids in the electrodepositable coating composition. In such compositions, other polymers may be present aside from the active hydrogen-containing film-forming resin(s) discussed earlier. For example, such compositions can be formulated with an additional ionic-film forming polymer, such as the cationic salt group containing film forming polymers discussed earlier that, as discussed above, may be added to the dispersion prior to the chain extension step, if desired.

Therefore, in certain embodiments, the electrodepositable compositions of the present invention comprise a mixture of polymers, such as the mixture of a cationic polyepoxide polymer and a cationic acrylic polymer discussed earlier.

In certain embodiments, the present invention is directed to photodegradation resistant electrodepositable coating compositions and related methods. As used herein, the term “photodegradation resistant” means that the electrodepositable coating composition can be used to form a primer layer in a multi-layer composite coating comprising a cured primer layer over at least a portion of a substrate, and a cured top coat layer over at least a portion of the cured primer layer, wherein the multi-layer composite coating exhibits substantially no interlayer delamination between the cured primer coating layer and the cured top coat layer upon concentrated solar spectral irradiance exposure equivalent to two years outdoor weathering when the top coat layer has at least 80 percent light transmission as measured at 400 nanometers, as described in detail in U.S. Patent Application Publication 2003/0054193 A1 at [0158] to [0161], which is incorporated herein by reference.

In certain embodiments, electrodepositable coating compositions of the present invention also comprise at least one source of a metal selected from rare earth metals, yttrium, bismuth, zirconium, tungsten, and mixtures thereof. In certain embodiments, the at least one source of metal is present in the electrodepositable composition in an amount of 0.005 to 5 percent by weight metal, based on the total weight of resin solids in the composition.

Both soluble and insoluble yttrium compounds may serve as the source of yttrium in such electrodepositable compositions. Examples of suitable yttrium sources include soluble organic and inorganic yttrium salts such as yttrium acetate, yttrium chloride, yttrium formate, yttrium carbonate, yttrium sulfamate, yttrium lactate and yttrium nitrate. When the yttrium is to be added to the composition as an aqueous solution, yttrium nitrate, a readily available yttrium compound, is a preferred yttrium source. Other suitable yttrium compounds are organic and inorganic yttrium compounds such as yttrium oxide, yttrium bromide, yttrium hydroxide, yttrium molybdate, yttrium sulfate, yttrium silicate, and yttrium oxalate. Organoyttrium complexes and yttrium metal can also be used. When the yttrium is to be incorporated into the composition as a component in a pigment paste, yttrium oxide is the preferred source of yttrium.

Suitable rare earth metal compounds include soluble, insoluble, organic, and inorganic salts of rare earth metals, such as acetates, oxalates, formates, lactates, oxides, hydroxides, molybdates, etc., of the rare earth metals.

There are various methods by which the yttrium, bismuth, zirconium, tungsten, or rare earth metal compounds can be incorporated into an electrodepositable composition. A soluble compound may be added “neat,” that is, added directly to the composition without prior blending or reacting with other components. Alternatively, a soluble compound can be added to the predispersed clear polymer feed which may include the ungelled, active hydrogen-containing film-forming polymer, the curing agent and/or any other non-pigmented component. Insoluble compounds and/or metal pigments, on the other hand, may be pre-blended with a pigment paste component prior to the incorporation of the paste to the electrodepositable composition.

The electrodepositable coating compositions of the present invention may further comprise a hindered amine light stabilizer for added UV degradation resistance. Suitable hindered amine light stabilizers include those disclosed in U.S. Pat. No. 5,260,135. In certain embodiments, these materials are present in the electrodepositable composition in an amount of 0.1 to 2 percent by weight, based on the total weight of polymer solids in the electrodepositable composition.

A pigment composition and other optional additives, such as surfactants, wetting agents, and/or catalysts can be included in the electrodepositable coating compositions. The pigment composition may be of the conventional type comprising inorganic pigments, for example, iron oxides, china clay, carbon black, coal dust, titanium dioxide, talc, barium sulfate, as well as organic color pigments such as phthalocyanine green and the like. The pigment content of the composition is usually expressed as a pigment-to-polymer ratio. When pigment is employed, the pigment-to-polymer ratio is usually within the range of about 0.02 to 1:1. The other additives mentioned above are usually in the dispersion in amounts of about 0.01 to 3 percent by weight based on weight of polymer solids.

In certain embodiments, the electrodepositable compositions of the present invention have a polymer solids content of 5 to 25 percent by weight based on the total weight of the composition.

In certain embodiments, the present invention is also directed to methods for coating an electroconductive substrate. In certain embodiments, such methods comprise (a) electrophoretically depositing on the substrate an electrodepositable coating composition, such as a composition described above, to form an electrodeposited coating over at least a portion of the substrate, and (b) heating the coated substrate to a temperature and for a time sufficient to cure the electrodeposited coating on the substrate. In certain embodiments, such methods comprise (a) electrophoretically depositing on the substrate an electrodepositable coating composition, such as a composition described above, to form an electrodeposited coating over at least a portion of the substrate, (b) heating the coated substrate to a temperature and for a time sufficient to cure the electrodeposited coating on the substrate, (c) applying directly to the cured electrodeposited coating one or more pigment-containing coating compositions and/or one or more pigment-free coating compositions to form a top coat over at least a portion of the cured electrodeposited coating, and (d) heating the coated substrate of step (c) to a temperature and for a time sufficient to cure the top coat.

In these methods, the electrodepositable coating composition can be electrophoretically deposited onto at least a portion of any of a variety of electroconductive substrates, including various metallic substrates. For example, suitable metallic substrates can include ferrous metals and non-ferrous metals. Suitable ferrous metals include iron, steel, and alloys thereof. Non-limiting examples of useful steel materials include cold-rolled steel, galvanized (i.e., zinc coated) steel, electrogalvanized steel, stainless steel, pickled steel, GALVANNEAL®, GALVALUME®, and GALVAN® zinc-aluminum alloys coated upon steel, and combinations thereof. Useful non-ferrous metals include conductive carbon coated materials, aluminum, copper, zinc, magnesium and alloys thereof. Cold rolled steel also is suitable when pretreated with a solution such as a metal phosphate solution, an aqueous solution containing at least one Group IIIB or IVB metal, an organophosphate solution, an organophosphonate solution and combinations of the above as are discussed below. Combinations or composites of ferrous and non-ferrous metals can also be used.

In these methods of the present invention, the electrodepositable coating compositions can be applied to either bare metal or pretreated metal. By “bare metal” is meant a virgin metal substrate that has not been treated with a pretreatment composition such as conventional phosphating solutions, heavy metal rinses and the like. Additionally, for purposes, of the present invention, bare metal substrates can include a cut edge of a substrate that is otherwise treated and/or coated over the non-edge surfaces of the substrate.

Before any treatment or application of any coating composition, the substrate optionally may be formed into an object of manufacture. A combination of more than one metal substrate can be assembled together to form such an object of manufacture.

Also, it should be understood that as used herein, an electrodepositable composition or coating formed “over” at least a portion of a “substrate” refers to a composition formed directly on at least a portion of the substrate surface, as well as a composition or coating formed over any coating or pretreatment material which was previously applied to at least a portion of the substrate.

That is, the “substrate” upon which the coating composition is electrodeposited can comprise any of the above-described electroconductive substrates to which one or more pretreatment and/or primer coatings have been previously applied. For example, the “substrate” can comprise a metallic substrate and a weldable primer coating over at least a portion of the substrate surface. The electrodepositable coating composition described above is then electrodeposited and cured over at least a portion thereof. One or more top coating compositions as described in detail below can be subsequently applied over at least a portion of the cured electrodeposited coating.

For example, the substrate can comprise any of the foregoing electroconductive substrates and a pretreatment composition applied over at least a portion of the substrate, the pretreatment composition comprising a solution that contains one or more Group IIIB or IVB element-containing compounds or mixtures thereof solubilized or dispersed in a carrier medium, typically an aqueous medium. The Group IIIB and IVB elements are defined by the CAS Periodic Table of the Elements as shown, for example, in the Handbook of Chemistry and Physics, (60th Ed. 1980). Transition metal compounds and rare earth metal compounds typically are compounds of zirconium, titanium, hafnium, yttrium and cerium and mixtures thereof. Typical zirconium compounds may be selected from hexafluorozirconic acid, alkali metal and ammonium salts thereof, ammonium zirconium carbonate, zirconyl nitrate, zirconium carboxylates and zirconium hydroxy carboxylates, such as hydrofluorozirconic acid, zirconium acetate, zirconium oxalate, ammonium zirconium glycolate, ammonium zirconium lactate, ammonium zirconium citrate, and mixtures thereof.

The pretreatment composition carrier also can contain a film-forming resin, for example, the reaction products of one or more alkanolamines and an epoxy-functional material containing at least two epoxy groups, such as those disclosed in U.S. Pat. No. 5,653,823. Other suitable resins include water soluble and water dispersible polyacrylic acids, such as those as disclosed in U.S. Pat. Nos. 3,912,548 and 5,328,525; phenol-formaldehyde resins as described in U.S. Pat. No. 5,662,746; water-soluble polyamides, such as those disclosed in WO 95/33869; copolymers of maleic or acrylic acid with allyl ether as described in Canadian patent application 2,087,352; and water soluble and dispersible resins including epoxy resins, aminoplasts, phenol-formaldehyde resins, tannins, and polyvinyl phenols, as discussed in U.S. Pat. No. 5,449,415.

Further, nonferrous or ferrous substrates can be pretreated with a non-insulating layer of organophosphates or organophosphonates, such as those described in U.S. Pat. Nos. 5,294,265 and 5,306,526. Such organophosphate or organophosphonate pretreatments are available commercially from PPG Industries, Inc. under the trade name NUPAL®. Application of a non-conductive coating, such as NUPAL, to the substrate may be followed by rinsing the substrate with deionized water prior to the coating coalescence to ensure that the non-conductive coating layer is sufficiently thin to be non-insulating. The pretreatment coating composition may comprise a surfactant to improve wetting of the substrate. Other optional materials in the carrier medium include defoamers and substrate wetting agents.

The pretreatment coating composition may be free of chromium-containing materials, i.e., the composition contains less than about 2 weight percent of chromium-containing materials (expressed as CrO₃), such as less than about 0.05 weight percent of chromium-containing materials.

In certain pre-treatment processes, before depositing the pretreatment composition upon the surface of the metal substrate, foreign matter is removed from the metal surface by thoroughly cleaning and degreasing the surface. Such cleaning may be accomplished by physical or chemical means, such as by mechanically abrading the surface or cleaning/degreasing with commercially available alkaline or acidic cleaning agents, such as sodium metasilicate and sodium hydroxide. A non-limiting example of a suitable cleaning agent is CHEMKLEEN® 163, an alkaline-based, cleaner commercially available from PPG Pretreatment and Specialty Products of Troy, Mich. Acidic cleaners also can be used. Following the cleaning step, the metal-substrate may be rinsed with water and then air-dried using, for example, an air knife, by flashing off the water by brief exposure of the substrate to a high temperature, or by passing the substrate between squeegee rolls. The pretreatment coating composition can be deposited upon at least a portion of the outer surface of the metal substrate. The thickness of the pretreatment film can vary, but is often less than 1 micrometer, such as from 1 to 500 nanometers, or, in some cases, from 10 to 300 nanometers.

The pretreatment coating composition may be applied to the surface of the metal substrate by any conventional application technique, such as by spraying, immersion or roll coating in a batch or continuous process. The temperature of the pretreatment coating composition at application is sometimes 10° C. to 85° C., such as 15° C. to 60° C. In some cases, the pH of the pretreatment coating composition at application is from 2.0 to 5.5, such as 3.5 to 5.5. The pH of the medium may be adjusted using mineral acids such as hydrofluoric acid, fluoroboric acid, phosphoric acid, and the like, including mixtures thereof; organic acids such as lactic acid, acetic acid, citric acid, sulfamic acid, or mixtures thereof, and water soluble or water dispersible bases such as sodium hydroxide, ammonium hydroxide; ammonia, or amines such as triethylamine, methylethyl amine, or mixtures thereof.

The pretreatment coating composition can be applied by any conventional process, such as a continuous process. For example, in the coil industry, the substrate is often cleaned and rinsed and then contacted with the pretreatment coating composition by roll coating with a chemical coater. The treated strip is then dried by heating, painted and baked by conventional coil coating processes.

Mill application of the pretreatment composition can be by immersion, spray or roll coating applied to the freshly manufactured metal strip. Excess pretreatment composition is sometimes removed by wringer rolls. After the pretreatment composition is applied to the metal surface, the metal may be rinsed with deionized water and dried at room temperature or at elevated temperatures to remove excess moisture from the treated substrate surface and cure any curable coating components to form the pretreatment coating. Alternately, in some cases, the treated substrate is heated to a temperature ranging from 65° C. to 125° C. for 2 to 30 seconds to produce a coated substrate having a dried residue of the pretreatment coating composition thereon. If the substrate is already heated from the hot melt production process, no post application heating of the treated substrate is required to facilitate drying. The temperature and time for drying the coating will depend upon such variables as the percentage of solids in the coating, components of the coating composition and type of substrate.

In some cases, the film coverage of the residue of the pretreatment composition is from 1 to 10,000 milligrams per square meter (mg/m²), such as 10 to 400 mg/m².

A layer of a weldable primer also may be applied to the substrate, whether or not the substrate has been pretreated. A typical weldable primer is BONAZINC® a zinc-rich mill applied organic film-forming composition, which is commercially available from PPG Industries, Inc., Pittsburgh, Pa. BONAZINC is often applied to a thickness of at least 1 micrometer, such as a thickness of 3 to 4 micrometers. Other suitable weldable primers, such as iron phosphide-rich primers are commercially available.

The electrodeposition process often involves immersing the electroconductive substrate into an electrodeposition bath of an aqueous electrodepositable composition, the substrate serving as a cathode in an electrical circuit comprising the cathode and an oppositely charged counter-electrode, i.e., an anode. Sufficient electrical current is applied between the electrodes to deposit a substantially continuous, adherent film of the electrodepositable coating composition onto the surface of the electroconductive substrate. Electrodeposition is often carried out at a constant voltage in the range of from 1 volt to several thousand volts, such as 50 to 500 volts. Maximum current density is often between 1.0 ampere and 15 amperes per square foot (10.8 to 161.5 amperes per square meter) and tends to decrease quickly during the electrodeposition process, indicating formation of a continuous self-insulating film.

In the electrodeposition process, the metal substrate being coated, serving as a cathode, and an electrically conductive anode are placed in contact with the cationic electrodepositable composition. Upon passage of an electric current between the cathode and the anode while they are in contact with the electrodepositable composition, an adherent film of the electrodepositable composition will deposit in a substantially continuous manner on the electroconductive substrate.

In certain embodiments, the present invention is directed to methods for forming a photodegradation-resistant multi-layer coating on an electrically conductive substrate comprising (a) depositing on the substrate an electrodepositable coating composition as described above to form an electrodeposited coating over at least a portion of the substrate, the substrate serving as a cathode in an electrical circuit comprising the cathode and an anode, the cathode and the anode being immersed in the electrodepositable coating composition, wherein electric current is passed between the cathode and the anode to cause the coating to be electrodeposited over at least a portion of the substrate; (b) heating the coated substrate at a temperature and for a time sufficient to cure the electrodeposited coating on the substrate; (c) applying directly to the cured electrodeposited coating one or more pigment-containing coating compositions and/or one or more pigment-free coating compositions to form a top coat over at least a portion of the cured electrodeposited coating; and (d) heating the coated substrate of step (c) to a temperature and for a time sufficient to cure the top coat. In these methods, a non-ferrous anode, for example, anodes comprised of ruthenium oxide or carbon rods, are included in the circuit.

In most conventional cationic electrodeposition bath systems, the anode(s) are comprised of a ferrous material, for example, stainless steel. A typical cationic bath has an acidic pH ranging from 4 to 7, often from 5 to 6.5. However, in a typical electrodeposition bath system, the anolyte (i.e., the bath solution in the immediate area of the anode) can have a pH as low as 3.0 or less due to the concentration of acid at or near the anode. At these strongly acidic pH ranges, the ferrous anode can degrade, thereby releasing soluble iron into the bath. By “soluble iron” is meant Fe²⁺ or Fe³⁺ salts which are at least partially water soluble. During the electrodeposition process, the soluble iron is electrodeposited along with the resinous binder and is present in the cured electrodeposited coating. It has been found that the presence of iron in soluble form can contribute to interlayer delamination of subsequently applied top coat layers from the cured electrodeposited coating layer upon weathering exposure. In view of the foregoing, it is desirable that electrodepositable coating compositions, when in the form of an electrodeposition bath, comprise less than 10 parts per million, typically less than 1 part per million of soluble iron. This can be accomplished by the inclusion in the circuit of a non-ferrous anode.

Once the electrodepositable coating composition is electrodeposited over at least a portion of the electroconductive substrate, the coated substrate is heated to a temperature and for a time sufficient to cure the electrodeposited coating on the substrate. In certain embodiments, the coated substrate is heated to a temperature ranging from 250° F. to 450° F. (121.1.° C. to 232.2° C.), such as from 275° F. to 400° F. (135° C. to 204.4° C.), or, in some cases, from 300° F. to 360° F. (149° C. to 180° C.). The curing time can be dependent upon the curing temperature as well as other variables, for example, film thickness of the electrodeposited coating, level and type of catalyst present in the composition and the like. For purposes of the present invention, all that is necessary is that the time be sufficient to effect cure of the electrodeposited coating on the substrate. For example, the curing time can range from 10 minutes to 60 minutes, such as from 20 to 40 minutes.

In certain embodiments, the coated substrate is heated to a temperature of 360° F. (180° C.) or less for a time sufficient to effect cure of the electrodeposited coating on the substrate. The thickness of the resultant cured electrodeposited coating often ranges from 15 to 50 microns.

As used herein, the term “cure” as used in connection with a composition, e.g., “a cured composition” shall mean that any crosslinkable components of the composition are at least partially crosslinked. In certain embodiments of the present invention, the crosslink density of the crosslinkable components, i.e., the degree of crosslinking, ranges from 5% to 100% of complete crosslinking. In other embodiments, the crosslink density ranges from 35% to 85% or, in some cases, 50% to 85% of full crosslinking. One skilled in the art will understand that the presence and degree of crosslinking, i.e., the crosslink density, can be determined by a variety of methods, such as dynamic mechanical thermal analysis (DMTA) using a TA Instruments DMA 2980 DMTA analyzer conducted under nitrogen. This method determines the glass transition temperature and crosslink density of free films of coatings or polymers. These physical properties of a cured material are related to the structure of the crosslinked network. For purposes of the present invention, a cured composition, when subjected to double rubs with a cloth soaked in acetone, will endure at least 100 double rubs without removing the coating.

In other embodiments, the present invention is directed to methods wherein an electrodepositable coating composition is electrophoretically applied to an electroconductive substrate and heated in an atmosphere having 5 parts per million or less, such as 1 part per million or less, of nitrogen oxides (NOₓ) to a temperature and for a time sufficient to cure the electrodeposited coating on the substrate as described above. The presence of NOₓ in the curing ovens can create an oxidizing atmosphere which can result in interlayer delamination between the cured electrodeposited coating and any subsequently applied top coats upon weathering exposure.

Once the electrodeposited coating is cured on the substrate in accordance with certain methods of the present invention, one or more pigment-containing coating compositions and/or one or more pigment-free coating compositions are applied directly to the cured electrodeposited coating. In the instance in which a single layer coating is desired, no topcoat application is necessary.

In certain embodiments, the use of a primer or primer-surfacer is unnecessary because of the improved photodegradation resistance afforded by certain electrodepositable compositions disclosed herein. Suitable top coats (including base coats, clear coats, pigmented monocoats, and color-plus-clear composite compositions) include any of those known in the art, and each independently may be waterborne, solventborne, in solid particulate form, i.e., a powder coating composition, or in the form of a powder slurry. The top coat typically includes a film-forming polymer, crosslinking material and, if a colored base coat or monocoat, one or more pigments.

Non-limiting examples of suitable base coat compositions include waterborne base coats such as are disclosed in U.S. Pat Nos. 4,403,003; 4,147,679; and 5,071,904. Suitable clear coat compositions include those disclosed in U.S. Pat. Nos. 4,650,718; 5,814,410; 5,891,981; and WO 98/14379.

The top coat compositions can be applied by conventional means including brushing, dipping, flow coating, spraying and the like, but they are most often applied by spraying. The usual spray techniques and equipment for air spraying and electrostatic spraying and either manual or automatic methods can be used. After application of each top coat to the substrate, a film is formed on the surface of the substrate by driving organic solvent and/or water out of the film by heating or by an air-drying period.

Typically, the thickness of a pigmented base coat ranges from 0.1 to 5 mils (2.54 to 127 microns), such as 0.4 to 1.5 mils (10.16 to 38.1 microns). The thickness of a clear coat often ranges from 0.5 to 5 mils (12.7 to 127 microns), such as 1.0 to 3 mils (25.4 to 76.2 microns).

The heating should be sufficient to ensure that any subsequently applied top coating can be applied without any dissolution occurring at the coating interfaces. Suitable drying conditions will depend on the particular top coat composition and on the ambient humidity (if the top coat composition is waterborne), but in general a drying time of from 1to 5 minutes at a temperature of 80° F. to 250° F. (20° C. to 121° C.) is used. Usually between coats, the previously applied coat is flashed, that is, exposed to ambient conditions for 1 to 20 minutes.

After application of the top coat composition(s), the coated substrate is then heated to a temperature and for a period of time sufficient to effect cure of the coating layer(s). In the curing operation, solvents are driven off and the film-forming materials of the top coats are each crosslinked. The heating or curing operation is often carried out at a temperature in the range of from 160° F. to 350° F. (71° C. to 177° C.) but if needed, lower or higher temperatures may be used as necessary to activate crosslinking mechanisms. Cure is as defined as above.

In certain embodiments, when cured, the top coats described above can have at least 0.1 percent light transmission as measured at 400 nanometers. The percent light transmission is determined by measuring light transmission of free cured top coat films ranging from 1.6 to 1.8 mils (40.64 to 45.72 micrometers) film thicknesses using a Perkin-Elmer Lambda 9 scanning spectrophotometer with a 150 millimeter Lap Sphere integrating sphere. Data is collected using Perkin-Elmer UV WinLab software in accordance with ASTM E903, Standard Test Method for Solar Absorbance, Reflectance, and Transmittance of Materials Using Integrating Spheres.

Illustrating the invention are the following examples, which, however, are not to be considered as limiting the invention to their details. Unless otherwise-indicated, all parts and percentages in the following examples, as well as throughout the specification, are by weight.

### EXAMPLES

### Example A

This example describes the preparation of a stable dispersion in water of a resinous phase-comprising an ungelled, active hydrogen-containing, film-forming resin. The components and amounts are provided in Table 1.

TABLE 1

| Components | Description | Mass (grams) |
|---|---|---|
| A | methyl isobutyl ketone | 147.11 |
| | Tinuvin 1130¹ | 14.91 |
| B | ethyl acrylate | 340.02 |
| | styrene | 160.01 |
| | hydroxypropyl methacrylate | 64.01 |
| | methyl methacrylate | 116.00 |
| | glycidyl methacrylate | 120.02 |
| | t-dodecyl mercaptan | 3.99 |
| | Vazo 67² | 13.99 |
| | Dowanol PNB³ | 25.61 |
| | Dowanol PM⁴ | 12.80 |
| | methyl isobutyl ketone | 10.38 |
| C | Vazo 67 | 0.93 |
| | Dowanol PNB | 1.71 |
| | Dowanol PM | 0.85 |
| | methyl isobutyl ketone | 0.69 |
| D | Luperox 7M50⁵ | 16.03 |
| | Dowanol PNB | 12.80 |
| | methyl isobutyl ketone | 6.40 |
| E | diethanolamine | 72.01 |
| F | DETA diketimine⁶ | 60.33 |
| G | crosslinker⁷ | 656.63 |
| H | sulfamic acid | 50.65 |
| | deionized water | 4098.13 |

¹Light stabilizer available from Ciba Geigy Corporation.
²2,2′-azobis(2-methylbutyronitrile) available from Du Pont-Specialty Chemicals.
³N-butoxypropanol solvent available from Dow Chemical Co.
⁴Propylene glycol monomethyl ether solvent available from Dow Chemical Co.
⁵50% t-butyl peroxyacetate in mineral spirits available from Arkema Inc.
⁶Diketimine formed from diethylene triamine and methylisobutyl ketone (72.69% solids in methylisobutyl ketone).
⁷Blocked isocyanate curing agent, 79.5% solids in methylisobutyl ketone. Prepared by reacting 10 equivalents of isophorone diisocyanate with 1 equivalent of trimethylol propane, 3 equivalents of bisphenol A-ethylene oxide polyol (prepared at a bisphenol A to ethylene oxide molar ratio of 1:6) and 6 equivalents of primary hydroxy from 1,2-butane diol.

Components A were raised to reflux in a 3 liter flask fitted with a stirrer, thermocouple, nitrogen inlet and a Dean and Stark condenser. The temperature was adjusted throughout the process to maintain reflux until noted otherwise. Components B were added at a uniform rate over 150 minutes, followed immediately by components C over 10 minutes. After a further 10 minutes components D were added over 10 minutes. 90 minutes later component E was added followed, 90 minutes later by component F. After 60 minutes component G was added and the temperature was allowed to fall to 105° C. over 60 minutes.

Meanwhile components H were heated to 50° C. in a separate vessel 1764 grams of the reaction mixture were then poured into components H under rapid agitation. The resulting dispersion had a solids content of 25%.

### Examples B1 to B3

The dispersion prepared in Example A was split into three equal parts. For Example B1, solvent was removed from part 1 by distillation under reduced pressure. For Example B2, part 2 was stirred at room temperature while 1% TMXDI on solids as a 50% by weight solution in methylisobutyl ketone was added over one hour. Solvent was then removed by distillation under reduced pressure. For Example B3, part 3 was stirred at room temperature while 2% TMXDI on solids as a 50% by weight solution in methylisobutyl ketone was added over one hour. Solvent was then removed by distillation under reduced pressure.

### Examples B4 and B5

For Example B4, 700 grams of the dispersion prepared in Example A was mixed with 627 grams of the resin prepared in Example H of U.S. Patent Application Publication 2003/0054193 A1. For Example B5, the mixture of Example B4 was stirred at room temperature while a mixture of 2.26 g of TMXDI and 2.26 g of methylisobutyl ketone was added over one hour. Solvent was then removed by distillation under reduced pressure.

### Examples C1 to C3

This example describes the preparation of a dispersion in water of a resinous phase comprising an active hydrogen-containing, film-forming resin. The components and amounts are provided in Table 2. The Example was repeated three times for Examples C1 to C3.

TABLE 2

| Components | Description | Mass (grams) |
|---|---|---|
| A | methyl isobutyl ketone | 92.28 |
| | Tinuvin 1130⁸ | 9.36 |
| B | ethyl acrylate | 213.29 |
| | styrene | 100.37 |
| | hydroxypropyl methacrylate | 40.15 |
| | methyl methacrylate | 72.77 |
| | glycidyl methacrylate | 75.29 |
| | t-dodecyl mercaptan | 2.51 |
| | Vazo 67⁹ | 8.03 |
| | Dowanol PNB¹⁰ | 16.06 |
| | Dowanol PM¹¹ | 8.03 |
| | methyl isobutyl ketone | 6.51 |
| C | Vazo 67 | 0.54 |
| | Dowanol PNB | 1.07 |
| | Dowanol PM | 0.54 |
| | methyl isobutyl ketone | 0.43 |
| D | Luperox 7M50¹² | 10.06 |
| | Dowanol PNB | 8.03 |
| | methyl isobutyl ketone | 4.01 |
| E | diethanolamine | 43.86 |
| F | DETA diketimine¹³ | 36.74 |
| G | Crosslinker¹⁴ | 409.64 |
| H | sulfamic acid | 29.23 |
| | deionized water | 2420.49 |

⁸Light stabilizer available from Ciba Geigy Corporation.
⁹2,2′-azobis(2-methylbutyronitrile) available from Du Pont Specialty Chemicals.
¹⁰N-butoxypropanol solvent available from Dow Chemical Co.
¹¹Propylene glycol monomethyl ether solvent available from Dow Chemical Co.
¹²50% t-butyl peroxyacetate in mineral spirits available from Arkema Inc.
¹³Diketimine formed from diethylene triamine and methylisobutyl ketone (72.69% solids in methylisobutyl ketone).
¹⁴Blocked isocyanate curing agent, 79.5% solids in methylisobutyl ketone. Prepared by reacting 10 equivalents of isophorone diisocyanate with 1 equivalent of trimethylol propane, 3 equivalents of bisphenol A-ethylene oxide polyol (prepared at a bisphenol A to ethylene oxide molar ratio of 1:6) and 6 equivalents of primary hydroxy from 1,2-butane diol.

Components A were raised to reflux in a 3 liter flask fitted with a stirrer, thermocouple, nitrogen inlet and a Dean and Stark condenser. The temperature was adjusted throughout the process to maintain reflux until noted otherwise. Components B were added at a uniform rate over 150 minutes, followed immediately by components C over 10 minutes. After a further 10 minutes components D were added over 10 minutes. 90 minutes later component E was added followed, 90 minutes later by component F. After 60 minutes component G was added and the temperature was allowed to fall to 105° C. over 60 minutes.

Meanwhile components H were heated to 50° C. in a separate vessel. 1764 grams of the reaction mixture were then poured into components H under rapid agitation. The resulting dispersion had a solids content of 25%. Solvent was removed by distillation under reduced pressure.

Resin Properties

| | | meq base | |
|---|---|---|---|
| Resin | Solids | (meq/g solids) | Mz |
| Example B1 | 31.8 | 0.752 | 438,571 |
| Example B2 | 30.6 | 0.660 | 621,457 |
| Example B3 | 29.7 | 0.633 | 1,036,286 |
| Example B4 | 35.5 | 0.656 | 396,971 |
| Example B5 | 35.6 | 0.615 | 444,338 |
| Example C1 | 31.2 | 0.731 | 557,391 |
| Example C2 | 30.9 | 0.736 | 631,297 |
| Example C3 | — | — | Gelled** |

**Sample gelled 45 minutes after the addition of component F.

### Coating Composition Example 1

This example describes the preparation of an electrodepositable coating composition in the form of an electrodeposition bath. The electrodeposition bath was prepared as described below and from a mixture of the ingredients listed in Table 3.

TABLE 3

| Ingredients | Parts By Weight (grams) |
|---|---|
| Cationic resin A¹⁵ | 636.8 |
| Cationic resin B¹⁶ | 495.2 |
| Plasticizer¹⁷ | 10.0 |
| Flexibilizer¹⁸ | 62.3 |
| Kathon¹⁹ | 0.7 |
| Pigment Paste²⁰ | 145.4 |
| Deionized Water | 1049.6 |

¹⁵The resin of Example B1.
¹⁶The resin prepared in Example H of United States Patent Application Publication 2003/0054193 A1.
¹⁷The reaction product of 2 moles of diethylene glycolbutyl ether and 1 mole of formaldehyde, prepared as described in U.S. Pat. No. 4,891,111.
¹⁸The reaction product of Jeffamine D400 (polyoxypropylenediamine available from Huntsman Corporation) and DER-732 (aliphatic epoxide commercially available from Dow Chemical Co), prepared as described in U.S. Pat. No. 4,423,166.
¹⁹A product commercially available from Rohm and Haas.
²⁰A pigment paste commercially available as E9003 from PPG Industries.

Under agitation, cationic resin A was diluted with 100 grams of deionized water. The plasticizer was added directly to the diluted cationic resin. The flexibilizer was diluted with 100 grams of deionized water and then added to the resin mixture under agitation. The Kathon was diluted with 100 grams of deionized water and then added to the resin mixture under agitation. The cationic resin B was separately diluted under agitation with 100 grams of deionized water, and then blended into the reduced resin mixture under agitation. The pigment paste was diluted with 100 grams of deionized water and added to the above resin blend. The remainder of the deionized water was then added to the resin mixture under agitation. Final bath solids were about 22%, with a pigment to resin ratio of 0.15:1.0. Twenty five percent of the total bath was removed by ultrafiltration and replaced with deionized water after the bath stirred for two hours. The paint was allowed to stir for an additional sixteen hours before any electrocoating occurred.

### Coating Composition Example 2

This example describes the preparation of an electrodepositable coating composition in the form of an electrodeposition bath. The electrodeposition bath was prepared as described in Example 1 and from a mixture of the ingredients listed in Table 4:

TABLE 4

| Ingredients | Parts By Weight (grams) |
|---|---|
| Cationic resin A²¹ | 661.7 |
| Cationic resin B²² | 495.2 |
| Plasticizer²³ | 10.0 |
| Flexibilizer²⁴ | 62.3 |
| Kathon²⁵ | 0.7 |
| Pigment Paste²⁶ | 145.4 |
| Deionized Water | 1024.7 |

²¹The resin of Example B2.
²²The resin prepared in Example H of United States Patent Application Publication 2003/0054193 A1.
²³The reaction product of 2 moles of diethylene glycolbutyl ether and 1 mole of formaldehyde, prepared as described in U.S. Pat. No. 4,891,111.
²⁴The reaction product of Jeffamine D400 (polyoxypropylenediamine available from Huntsman Corporation) and DER-732 (aliphatic epoxide commercially available from Dow Chemical Co), prepared as described in U.S. Pat. No. 4,423,166.
²⁵A product commercially available from Rohm and Haas.
²⁶A pigment paste commercially available as E9003 from PPG Industries.

### Coating Composition Example 3

This example describes the preparation of an electrodepositable coating composition in the form of an electrodeposition bath. The electrodeposition bath was prepared as described in Example 1 and from a mixture of the ingredients listed in Table 5:

TABLE 5

| Ingredients | Parts By Weight |
|---|---|
| Cationic resin A²⁷ | 681.8 |
| Cationic resin B²⁸ | 495.2 |
| Plasticizer²⁹ | 10.0 |
| Flexibilizer³⁰ | 62.3 |
| Kathon³¹ | 0.7 |
| Pigment Paste³² | 145.4 |
| Deionized Water | 1004.6 |

²⁷The resin of Example B3.
²⁸The resin prepared in Example H of United States Patent Application Publication 2003/0054193 A1.
²⁹The reaction product of 2 moles of diethylene glycolbutyl ether and 1 mole of formaldehyde, prepared as described in U.S. Pat. No. 4,891,111.
³⁰The reaction product of Jeffamine D400 (polyoxypropylenediamine available from Huntsman Corporation) and DER-732 (aliphatic epoxide commercially available from Dow Chemical Co), prepared as described in U.S. Pat. No. 4,423,166.
³¹A product commercially available from Rohm and Haas.
³²A pigment paste commercially available as E9003 from PPG Industries.

### Coating Composition-Example 4

This example describes the preparation of an electrodepositable coating composition in the form of an electrodeposition bath. The electrodeposition bath was prepared as described in Example 1 and from a mixture of the ingredients listed in Table 6:

TABLE 6

| Ingredients | Parts By Weight |
|---|---|
| Cationic resin A³³ | 649.0 |
| Cationic resin B³⁴ | 495.2 |
| Plasticizer³⁵ | 10.0 |
| Flexibilizer³⁶ | 62.3 |
| Kathon³⁷ | 0.7 |
| Pigment Paste³⁸ | 145.4 |
| Deionized Water | 1037.4 |

³³The resin of Example C1.
³⁴The resin prepared in Example H of United States Patent Application Publication 2003/0054193 A1.
³⁵The reaction product of 2 moles of diethylene glycolbutyl ether and 1 mole of formaldehyde, prepared as described in U.S. Pat. No. 4,891,111.
³⁶The reaction product of Jeffamine D400 (polyoxypropylenediamine available from Huntsman Corporation) and DER-732 (aliphatic epoxide commercially available from Dow Chemical Co), prepared as described in U.S. Pat. No. 4,423,166.
³⁷A product commercially available from Rohm and Haas.
³⁸A pigment paste commercially available as E9003 from PPG Industries.

### Coating Composition Example 5

This example describes the preparation of an electrodepositable coating composition in the form of an electrodeposition bath. The electrodeposition bath was prepared as described in Example 1 and from a mixture of the ingredients listed in Table 7:

TABLE 7

| Ingredients | Parts By Weight |
|---|---|
| Cationic resin³⁹ | 1139.6 |
| Plasticizer⁴⁰ | 10.0 |
| Flexibilizer⁴¹ | 62.3 |
| Kathon⁴² | 0.7 |
| Pigment Paste⁴³ | 145.4 |
| Deionized Water | 1042.0 |

³⁹The resin of Example B5.
⁴⁰The reaction product of 2 moles of diethylene glycolbutyl ether and 1 mole of formaldehyde, prepared as described in U.S. Pat. No. 4,891,111.
⁴¹The reaction product of Jeffamine D400 (polyoxypropylenediamine available from Huntsman Corporation) and DER-732 (aliphatic epoxide commercially available from Dow Chemical Co), prepared as described in U.S. Pat. No. 4,423,166.
⁴²A product commercially available from Rohm and Haas.
⁴³A pigment paste commercially available as E9003 from PPG Industries.

Electrocoating Process

Each of the electrodeposition bath compositions of Examples 1 through 5 above were electrodeposited onto two different substrates. One was a cold rolled steel substrate which had been pretreated with zinc phosphate pretreatment followed by a deionized water rinse; the second was an electro galvanized substrate which had been pretreated with zinc phosphate pretreatment followed by a deionized water rinse (commercially available as CRS C700DI and E60 EZG C700DI from ACT Laboratories, respectively). Conditions for cationic electrodeposition of each were as follows: 2 minutes at 90° F. (32° C.) at 225-250 volts to yield a cured film thickness of 1.0 to 1.1 mils. After a deionized water rinse, the electrocoated panels were cured in an electric coven at 360° F. (182 ° C.) for 30 minutes.

Testing Process

The cured electrocoat films were evaluated for film smoothness and oil spot resistance. Film thickness was measured using a Fisher Permascope. Film smoothness was measured-using a Gould Surfaralyzer 150. Recorded film thickness and smoothness were each based on an average of three measurements. Results for film smoothness are reported in the following Table 8.

Oil spot contamination resistance testing evaluates the ability of an electrodeposited coating, upon cure, to resist crater formation due to contaminants carried into the bath with the substrate. Panels were tested for oil spot resistance by spotting the top half of a CRS C700DI test panel with TRIBOL-ICO medium oil and the, bottom half of the panel with LUBECON ATS oil. These oils are representative of those typically used for chain lubrication in automotive assembly plants. The oil spotted test panels were then electrocoated and cured as described above to give a cured film thickness of 1.0-1.1 mils. Ratings for oil spot contamination resistance are reported in the following Table 8.

TABLE 8

| | | CRSC700DI | E60EZGC700DI | Oil |
|---|---|---|---|---|
| | | Smoothness | Smoothness | Resistance |
| Example | Description | (micro inches) | (micro inches) | Rating* |
| Example 1 | Control | 9.46 | 10.01 | 2 |
| Example 2 | 1% TMXDI | 7.25 | 9.59 | 6 |
| Example 3 | 2% TMXDI | 8.78 | 12.32 | 8 |
| Example 4 | 1:1 A:E | 8.85 | 9.70 | 5 |
| Example 5 | 1% TMXDI | 6.50 | 8.41 | 5 |
| | Preblend | | | |

*10 = best; 0 = worst

The results in Table 8 illustrate that electrodeposition bath compositions containing TMXDI exhibit improved oil spot resistance versus the control bath without TMXDI. Additionally, film smoothness was not adversely affected by the addition of 1% TMXDI.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

I claim:

1. A method for making a stable, aqueous dispersion comprising a high molecular weight resinous phase dispersed in a dispersing medium, the method comprising:
(a) forming a stable dispersion in the dispersing medium of an ungelled resinous phase comprising an active hydrogen-containing, film-forming resin; and
(b) chain extending the active hydrogen-containing film-forming resin in the stable dispersion to form the stable, aqueous dispersion comprising the high molecular weight resinous phase dispersed in the dispersing medium.

2. An electrodepositable coating composition comprising the aqueous dispersion made by the method of claim 1.

3. The electrodepositable coating composition of claim 2, wherein the stable dispersion comprises a resinous phase comprising a mixture of at least two different ungelled, active hydrogen-containing film-forming resins.

4. The electrodepositable coating composition of claim 3, wherein the mixture comprises a cationic polyepoxide polymer and cationic acrylic polymer.

5. The method of claim 1, wherein the active hydrogen-containing film-forming resin comprises an acrylic polymer.

6. The method of claim 5, wherein the active hydrogen-containing film-forming resin comprises cationic amine salt groups that are derived from pendant and/or terminal amino groups having the structure —NHR or 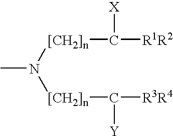
wherein R represents H or C₁ to C₁₈ alkyl; R¹, R², R³, and R⁴ are the same or different, and each independently represents H or C₁ to C₄ alkyl; n is an integer having a value ranging from 1 to 11; and X and Y can be the same or different, and each independently represents a hydroxyl group or an amino group.

7. The method of claim 1, wherein the ungelled resinous phase has a Z-average molecular weight of 100,000 to 600,000.

8. The method of claim 1 wherein prior to chain extension the active hydrogen-containing film-forming resin contains from 0.1 to 3.0 millequivalents of cationic salt groups per gram of polymer solids.

9. The method of claim 1, wherein the high molecular weight resinous phase has a Z-average molecular weight at least 25 percent greater than the ungelled resinous phase.

10. The method of claim 1, wherein the high molecular weight resinous phase has a Z-average molecular weight of at least 200,000.

11. The electrodepositable coating composition of claim 3, wherein the high molecular weight resinous phase has a Z-average molecular weight at least 5 percent greater than the ungelled resinous phase.

12. The electrodepositable coating composition of claim 3, wherein the high molecular weight resinous phase has a Z-average molecular weight of at least 150,000.

13. The method of claim 1, wherein chain extension of the active hydrogen-containing film-forming resin in the stable dispersion is accomplished by reacting the resin with a reactant comprising an unblocked polyisocyanate.

14. The method of claim 13, wherein the unblocked polyisocyanate comprises m-tetramethylxylene diisocyanate.

15. The method of claim 1, wherein, after chain extension, the active hydrogen-containing film-forming resin comprises from 0.02 to 0.3 fewer millequivalents of cationic salt groups per gram of resin solids than prior to chain extension.

16. An electrodepositable substrate at least partially coated with the electrodepositable coating composition of claim 2.

17. A curable, electrodepositable coating composition comprising a resinous, phase dispersed in an aqueous medium, wherein the resinous phase comprises:
(a) an at least partially blocked aliphatic polyisocyanate curing agent, and
(b) an active hydrogen-containing, cationic amine salt group-containing resin, which is electrodepositable on a cathode wherein the amine salt groups are derived from pendant and/or terminal amino salt groups having the structure: 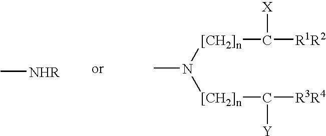
wherein R represents H or C₁ to C₁₈ alkyl; R¹, R², R³, and R⁴ are the same or different, and each independently represents H or C₁ to C₄ alkyl; and X and Y can be the same or different, and each independently, represents a hydroxyl group or an amino group, and
wherein the resinous phase has a Z-average molecular weight of at least 200,000.

18. The composition of claim 17, wherein the resinous phase has a Z-average molecular weight of from 500,000 to 1,500,000.

19. An electrodepositable substrate tat least partially coated with the composition of claim 17.

20. A method for coating an electroconductive substrate comprising:
(a) electrophoretically depositing on the substrate the electrodepositable coating composition of claim 17, and
(b) heating the coated substrate to a temperature and for a time sufficient to cure the electrodeposited coating on the substrate.

21. A multi-layer composite coating comprising a cured primer coating layer over at least a portion of an electroconductive substrate, and a cured top coat layer over at least a portion of the cured primer coating layer, the primer coating layer being formed from the curable, electrodepositable coating composition of claim 18.
